(19) United States
(12) Patent Application Publication
(10) Pub. No.: US 2022/0356897 A1
(43) Pub. Date: Nov. 10, 2022

(54) FASTENING STRUCTURE WITH TWO DIFFERENT THREADS

(71) Applicant: CHIEN-TING LIN, Santa Fe Springs, CA (US)

(72) Inventor: CHIEN-TING LIN, Santa Fe Springs, CA (US)

(21) Appl. No.: 17/739,232

(22) Filed: May 9, 2022

(30) Foreign Application Priority Data
May 10, 2021 (CN) 202121003870.6

(51) Int. Cl. F16B 33/02; F16B 37/00

(52) U.S. Cl. CPC F16B 33/02; F16B 37/00

(57) ABSTRACT

A fastening structure with two different threads includes: a rod body provided with a first thread and a second thread arranged at an outward protrusion of the first thread, wherein a pitch and a thread width of the first thread are larger than those of the second thread; and an outer member engaged on an outer side of the rod body and provided with a third thread and a fourth thread arranged at an outward protrusion of the third thread, wherein a pitch and a thread width of the third thread are larger than those of the fourth thread, and correspond to those of the first thread, and the pitch and the thread width of the fourth thread correspond to those of the second thread. When the rod body and the outer member are engaged to rotate in an unhindered manner, the first thread is engaged with the third thread, and the rod body and the outer member can be rapidly moved relative to each other. When the rod body and the outer member rotate relative to each other in a hindered manner, the first thread is disengaged from the third thread, the second thread is engaged with the fourth thread, the second thread and the fourth thread are locked with each other, and the rod body and the outer member are fixed with each other.

### BACKGROUND OF THE INVENTION

1. Field of the Invention

The present invention relates to a fastening structure, in particular to a fastening structure with two different threads.

2. The Prior Art

A conventional fastening structure with threads generally comprises a screw rod and a nut, and the screw rod and the nut are engaged with each other. When the screw rod and the nut are rotated relative to each other, the relative position of the screw rod and the nut will be changed. When the relative rotation of the screw rod and the nut is hindered, the screw rod and the nut are locked with each other and thus the relative position of the screw rod and the nut is kept unchanged.

The conventional fastening structure with threads has the defects that for a screw rod with a longer length and a smaller pitch, it takes a longer operation time to rotate the screw rod and the nut relative to each other to a locking position. Conversely, it also takes a longer operation time to rotate the screw rod and the nut relative to each other back to a proper position. For example, due to the high value of mobile phones and tablets to be clamped and the fear of falling and bumping, some users will choose a mobile phone holder or a tablet holder with a threaded fastening structure. When using the mobile phone holder or the tablet holder, it takes a longer operation time to rotate the screw and the nut relative to each other to a proper position, so that clamping portions at two ends of the mobile phone holder or the tablet holder are separated with each other up to the proper position, the mobile phone or the tablet is placed therein, then the screw and the nut are rotated relative to each other to a locking position, and finally the mobile phone or the tablet is fixed on the mobile phone holder or the tablet holder. On the contrary, after the mobile phone or the tablet is taken out therefrom, the clamping portions at the two ends of the mobile phone holder or the tablet holder need to be close relative to each other to a minimum accommodating distance, and therefore the screw rod and the nut need to be rotated relative to each other for a longer time, thereby causing an inconvenient in use.

### SUMMARY OF THE INVENTION

In order to overcome the disadvantage that the conventional fastening structure with a thread takes a longer operation time when in use, the present invention provides a fastening structure with two different threads comprising a rod body and an outer member. The rod body is provided with a first thread and a second thread, a pitch and a thread width of the first thread are larger than those of the second thread, and the second thread is arranged at an outward protrusion of the first thread. The outer member is provided with a third thread and a fourth thread, a pitch and a thread width of the third thread are larger than those of the fourth thread and correspond to those of the first thread, and the fourth thread is arranged at an outward protrusion of the third thread and corresponds to the second thread, so that the rod body and the outer member are engaged with each other. When the first thread and the third thread are engaged with each other and rotated relative to each other, because the pitch of the first thread and the third thread is larger, a relative position of the rod body and the outer member can be quickly moved. When the relative rotation of the rod body and the outer member is hindered, the first thread is disengaged from the third thread, and the second thread is engaged with the fourth thread to lock the rod body and the outer member with each other, and thus the rod body and the outer member are fixed with each other. The fastening structure with two different threads utilizes two different threads with different pitches to simultaneously implement the functions of quick movement and quick locking and loosening.

The technical solution adopted by the present invention for solving the above technical problem is to provide a fastening structure with two different threads comprising: a rod body provided with a first thread and a second thread arranged at an outward protrusion of the first thread, wherein a pitch and a thread width of the first thread are larger than those of the second thread; and an outer member engaged on an outer side of the rod body and provided with a third thread and a fourth thread arranged at an outward protrusion of the third thread, wherein a pitch and a thread width of the third thread are larger than those of the fourth thread and correspond to those of the first thread, and the pitch and the thread width of the fourth thread correspond to those of the second thread. When the rod body and the outer member are engaged with each other to rotate in an unhindered manner, the first thread is engaged with the third thread, and the rod body and the outer member can be rapidly moved relative to each other. When the rod body and the outer member rotate relative to each other in a hindered manner, the first thread is disengaged from the third thread, the second thread is engaged with the fourth thread, the second thread and the fourth thread are locked with each other, and thus the rod body and the outer member are fixed with each other. When the second thread and the fourth thread are loosened with each other, the second thread is disengaged from the fourth thread, the first thread is engaged with the third thread, and thus the rod body and the outer member can be rapidly moved relative to each other.

Preferably, the outer member is a ring-shape.

Preferably, the outer member is formed of at least one arc portion, and the third thread and the fourth thread of each arc portion are discontinuous but with continuity.

Preferably, the present invention further provides a holder including the fastening structure with two different threads described above, wherein the holder is used for clamping a mobile phone. The holder comprises a first clamping portion and a second clamping portion. The second clamping portion is provided with the outer member at a suitable location. The rod body is penetrated into the holder from an outside of the first clamping portion and penetrated through the outer member. One end of the rod body is provided with a position limiter for limiting relative positions of the rod body and the first clamping portion but allowing to rotate with respect to each other. The mobile phone is placed between the first clamping portion and the second clamping portion, by rotating the rod body, the first thread of the rod body and the third thread of the outer member are engaged and rotated relative to each other, the first clamping portion and the second clamping portion are rapidly moved toward each other for clamping the mobile phone, and then, the rod body is rotated toward a locking direction, the first thread and the third thread are disengaged from each other, and the second thread and the fourth thread are engaged with each other to fasten the rod body and the outer member with each other, so that the first clamping portion and the second clamping portion tightly clamp the mobile phone, otherwise, the rod body is rotated toward a loosening direction, the second thread and the fourth thread are disengaged from each other, the first thread and the third thread are engaged with each other, and the first clamping portion and the second clamping portion can be rapidly moved relative to each other, so that the mobile phone can be taken out of the holder.

The present invention has the advantages that the present invention uses two groups of threads with different pitches to simultaneously achieve the functions of quick movement and quick locking or loosening in the rod body and the outer member, has a simple structure, so as to avoid the risk of failure, and achieves the purposes of convenient carrying and easy operation. The present invention can be applied to products such as mobile phone holders or tablet holders, and can also be applied to other products which need to use a longer screw rod to adjust the distance and fix.

### BRIEF DESCRIPTION OF THE DRAWINGS

The present invention is further illustrated with reference to the following drawings and embodiments.

FIG. 1 is a first schematic view according to a first embodiment of the present invention;

FIG. 2 is a second schematic view according to the first embodiment of the present invention;

FIG. 3 is an exploded schematic view according to the first embodiment of the present invention;

FIG. 4A is a schematic view of a first thread and a third thread engaged with each other according to the first embodiment of the present invention;

FIG. 4B is a cross-sectional view of a first thread and a third thread engaged with each other taken along line AA of FIG. 4A according to the first embodiment of the present invention;

FIG. 5A is a schematic view of a second thread and a fourth thread engaged with each other according to the first embodiment of the present invention;

FIG. 5B is a cross-sectional view of a second thread and a fourth thread engaged with each other taken along line BB of FIG. 5A according to the first embodiment of the present invention;

FIG. 6A is a schematic view showing a combination of the rod body and a arc-shaped portion according to a second embodiment of the present invention;

FIG. 6B is a schematic view of a ring-shaped outer member according to the second embodiment of the present invention;

FIG. 6C is a schematic view of two arc portions of the ring-shaped outer member taken along line CC of FIG. 6B according to the second embodiment of the present invention;

FIG. 7A is a schematic view of a holder according to a third embodiment of the present invention;

FIG. 7B is a schematic view showing that the holder clamps a mobile phone according to the third embodiment of the present invention;

FIG. 8A is an exploded schematic view of a first clamping portion and a second clamping portion of the holder according to the third embodiment of the present invention;

FIG. 8B is a schematic side view of the holder according to the third embodiment of the present invention; and

FIG. 8C is a schematic cross-sectional view of the holder taken along line DD of FIG. 8B according to the third embodiment of the present invention.

### DETAILED DESCRIPTION OF THE PREFERRED EMBODIMENT

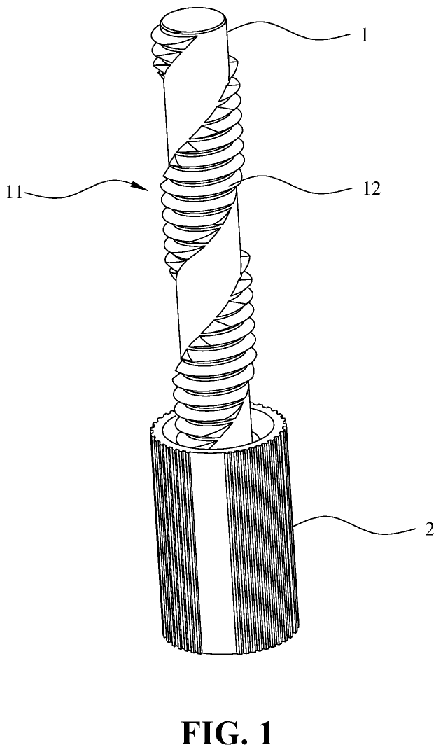

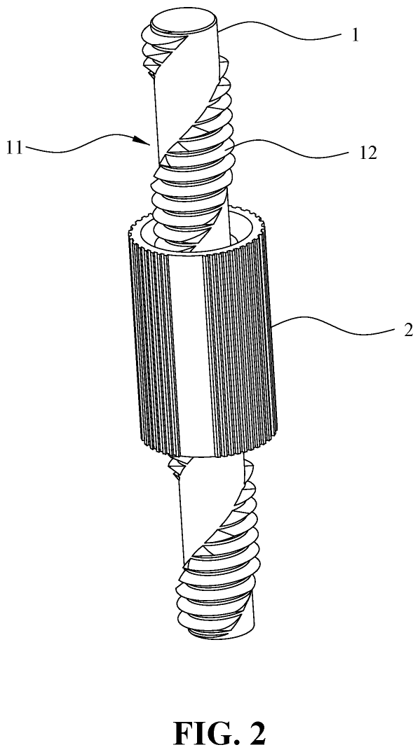

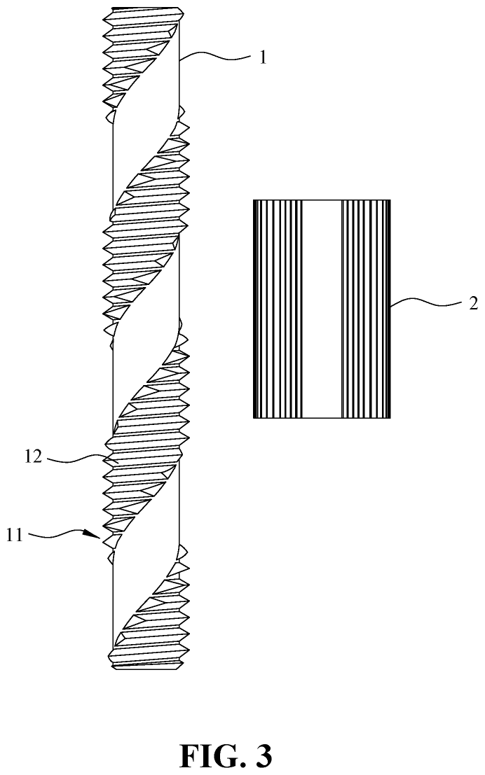

Embodiments of the present invention are described below with reference to FIGS. 1 to 8C. The description is not intended to limit the embodiments of the present invention but is one of the examples of the present invention.

FIGS. 1 to 5B show a fastening structure with two different threads according to a first embodiment of the present invention. The fastening structure with two different threads comprises: a rod body 1 is provided with a first thread 11 and a second thread 12 arranged at an outward protrusion of the first thread 11, wherein a pitch and a thread width of the first thread 11 are larger than those of the second thread 12; an outer member 2 is engaged on an outer side of the rod body 1 and provided with a third thread 21 and a fourth thread 22 arranged at an outward protrusion of the third thread 21, wherein a pitch and a thread width of the third thread 21 are larger than those of the fourth thread 22 and correspond to those of the first thread 11, and the pitch and the thread width of the fourth thread 22 correspond to those of the second thread 12. When the rod body 1 and the outer member 2 are engaged with each other to rotate in an unhindered manner, the first thread 11 is engaged with the third thread 21, and the rod body 1 and the outer member 2 can be rapidly moved relative to each other. When the rod body 1 and the outer member 2 rotate relative to each other in a hindered manner, the first thread 11 is disengaged from the third thread 21, the second thread 12 is engaged with the fourth thread 22, the second thread 12 and the fourth thread 22 are locked with each other, and thus the rod body 1 and the outer member 2 are fixed with each other. When the second thread 12 and the fourth thread 22 are loosened with each other, the second thread 12 is disengaged from the fourth thread 22, the first thread 11 is engaged with the third thread 21, and the rod body 1 and the outer member 2 can be rapidly moved relative to each other. The present invention uses two groups of threads with different pitches to simultaneously implement the functions of quick movement and quick locking and loosening on the rod body 1 and the outer member 2.

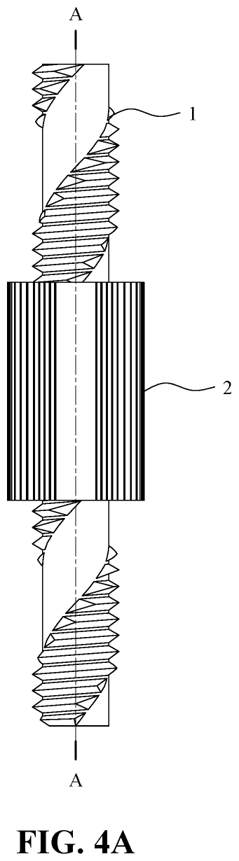

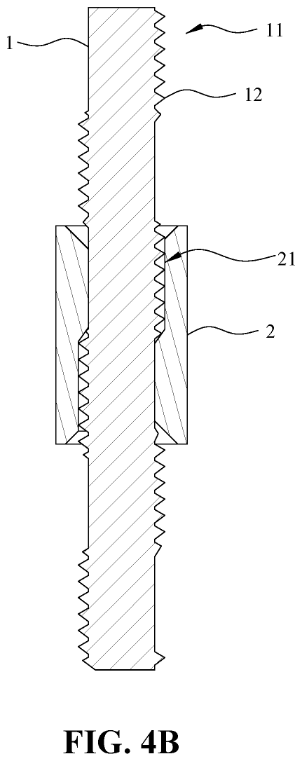

As shown in FIGS. 4A and 4B, which show the first thread 11 and the third thread 21 are engaged with each other according to the first embodiment of the present invention, the pitch of the first thread 11 and the third thread 21 is relatively large. When the first thread 11 and the third thread 21 having a relatively larger pitch are engaged with each other to rotate, the rod body 1 and the outer member 2 can be rapidly moved relative to each other, that is, when the rod body 1 and the outer member 2 rotate one turn relative to each other, one pitch distance of the first thread 11 or the third thread 21 can be relatively moved. For the rod body 1 and the outer member 2 corresponding to the rod body 1 of the same size according to the present invention, the pitch of the first thread 11 and the third thread 21 may affect the speed and smoothness of the relative movement of the rod body 1 and the outer member 2.

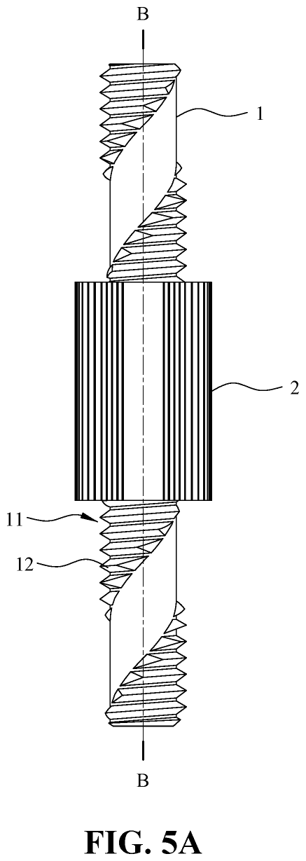

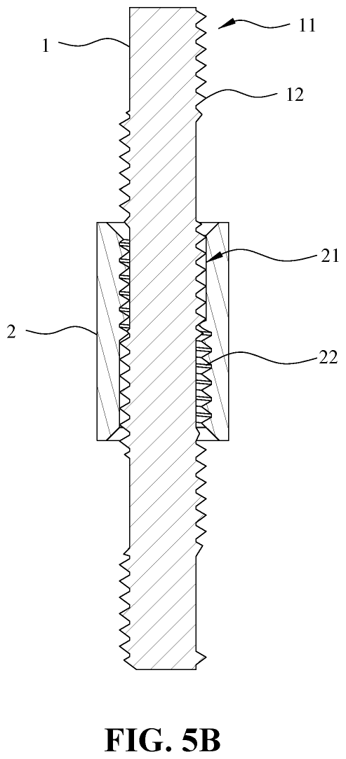

As shown in FIGS. 4A to 5B, the first thread 11 and the third thread 21 have a larger pitch so as to facilitate quick movement, but not to facilitate relative locking of the rod body 1 and the outer member 2, that is, the first thread 11 and the third thread 21 are mainly used for relative quick movement of the rod body 1 and the outer member 2, but not for mutual locking of the rod body 1 and the outer member 2. Therefore, the second thread 12 and the fourth thread 22 are required to be locked with each other, thereby fixing the rod body 1 and the outer member 2.

As shown in FIGS. 5A to 5B, which show the second thread 12 and the fourth thread 22 are engaged with each other according to the first embodiment of the present invention, the pitch of the second thread 12 and the fourth thread 22 is relatively small. When the rod body 1 and the outer member 2 rotate relative to each other in a hindered manner, the first thread 11 is disengaged with the third thread 21, the second thread 12 is engaged with the fourth thread 22, and thus the second thread 12 and the fourth thread 22 are locked with each other, and therefore the rod body 1 and the outer member 2 are fixed with each other. When the second thread 12 and the fourth thread 22 are loosened relative to each other, the second thread 12 is disengaged from the fourth thread 22, the first thread 11 is engaged with the third thread 21, and therefore the rod body 1 and the outer member 2 can be rapidly moved relative to each other. The pitch and the thread width of the second thread 12 and the fourth thread 22 of the present invention are relatively small, and thus the second thread 12 and the fourth thread 22 are mainly used for mutual locking of the rod body 1 and the outer member 2 with each other, but not for relative quick movement of the rod body 1 and the outer member 2.

As shown in FIG. 1, which shows the outer member according to the first embodiment of the present invention, the outer member 2 is a ring-shape, that is, the outer member 2 has a continuous third thread 21.

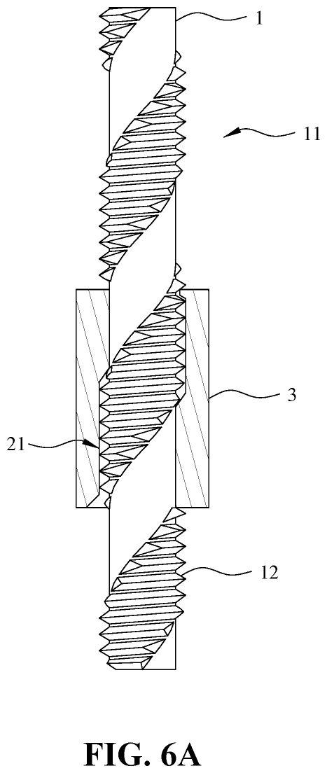

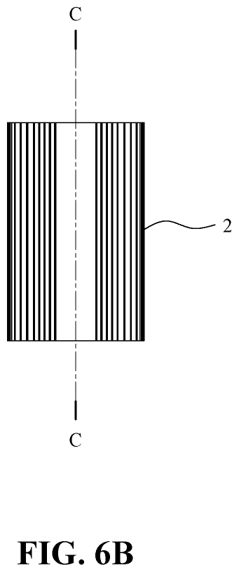

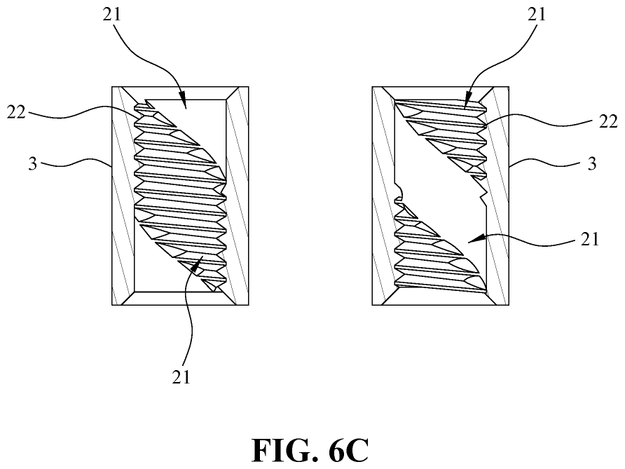

Please refer to FIGS. 6A to 6C, which are views of the outer member according to the second embodiment of the present invention. In FIG. 6A, the outer member 2 is formed of at least one arc portion 3, and the third thread 21 and the fourth thread 22 of each arc portion are discontinuous but with continuity and can correspond to the first thread 11 and the second thread 12 of the rod body 1, respectively. The outer member 2 of the present invention may be formed as a ring by two arc portions 3. As shown in FIGS. 6B and 6C, the ring is divided into two arc portions 3. Also, the ring may be formed of three arc portions 3. There may be a gap or no gap between the arc portions 3, but it is necessary to maintain continuity between the third thread 21 and the fourth thread 22, so that the rod body 1 and the outer member 2 can rotate smoothly.

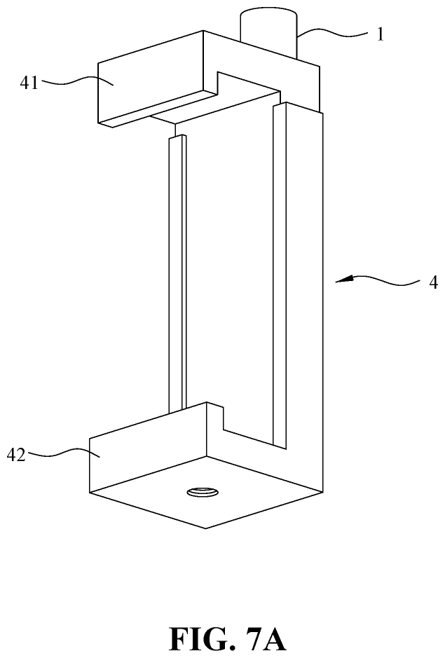

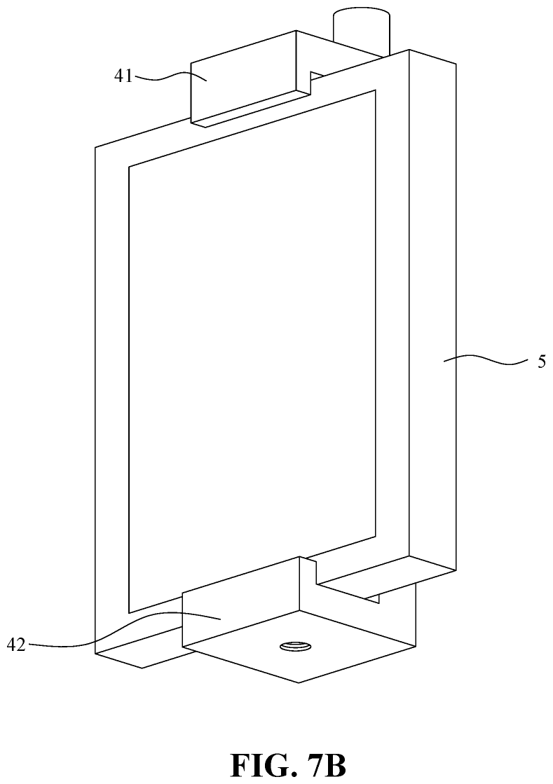

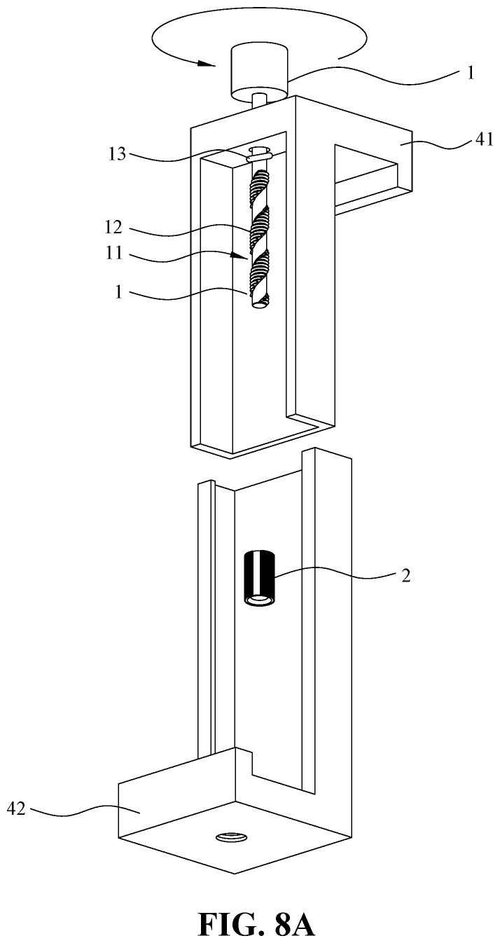

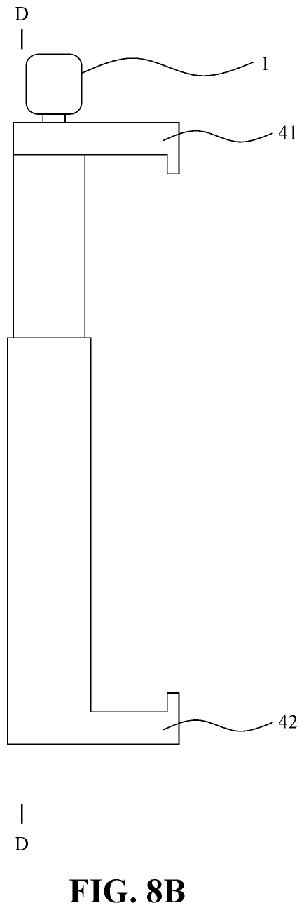

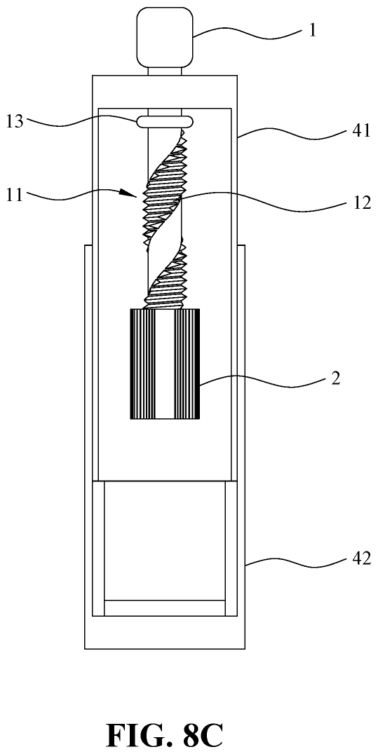

As shown in FIGS. 7A to 8C, a holder 4 according to a third embodiment of the present invention is further provided. The holder 4 is used for clamping a mobile phone 5. As shown in FIG. 8A, the holder 4 comprises a first clamping portion 41 and a second clamping portion 42, the second clamping portion 42 is provided with the outer member 2 at a suitable location, the rod body 1 is penetrated into the holder 4 from an outside of the first clamping portion 41 and penetrated through the outer member 2, one end of the rod body 1 is provided with a position limiter 13 for limiting relative positions of the rod body 1 and the first clamping portion 41 but allowing to rotate with respect to each other, the mobile phone 5 is placed between the first clamping portion 41 and the second clamping portion 42, by rotating the rod body 1, the first thread 11 of the rod body 1 and the third thread 21 of the outer member 2 are engaged and rotated relative to each other, the first clamping portion 41 and the second clamping portion 42 are rapidly moved toward each other for clamping the mobile phone 5, and then, the rod body 1 is rotated toward a locking direction, the first thread 11 and the third thread 21 are disengaged from each other, and the second thread 12 and the fourth thread 22 are engaged with each other to fasten the rod body 1 and the outer member 2 with each other, so that the first clamping portion 41 and the second clamping portion 42 tightly clamp the mobile phone 5, otherwise, the rod body 1 is rotated toward a loosening direction, the second thread 12 and the fourth thread 22 are disengaged from each other, the first thread 11 and the third thread 21 are engaged with each other, and the first clamping portion 41 and the second clamping portion 42 can be rapidly moved relative to each other, so that the mobile phone 5 can be taken out of the holder 4. The embodiment of the present invention can be applied to a mobile phone holder and can also be applied to a tablet holder to solve the defects that when the traditional mobile phone holder or tablet holder uses a single-thread long screw rod for fixing, two clamping portions cannot move quickly and the time is consumed.

Preferably, to increase the stability of the body 1 and the outer member 2 in rotation relative to each other, the first thread 11 may be a double or multiple thread, and the third thread 21 corresponds to the double or multiple thread of the first thread 11. Similarly, the second thread 12 may also be a double or multiple thread, and the fourth thread 22 corresponds to the double or multiple thread of the second thread 12.

While the foregoing description and description are of the preferred embodiment of the present invention, other modifications of the present invention shall be apparent to those skilled in the art from the following claims and their equivalents, and it is intended that such modifications shall be included within the scope of the appended claims.

What is claimed is:

1. A fastening structure with two different threads, comprising:
a rod body provided with a first thread and a second thread arranged at an outward protrusion of the first thread, wherein a pitch and a thread width of the first thread are larger than those of the second thread; and
an outer member engaged on an outer side of the rod body and provided with a third thread and a fourth thread arranged at an outward protrusion of the third thread, wherein a pitch and a thread width of the third thread are larger than those of the fourth thread and correspond to those of the first thread, and the pitch and the thread width of the fourth thread correspond to those of the second thread;
wherein when the rod body and the outer member are engaged with each other to rotate in an unhindered manner, the first thread is engaged with the third thread, and the rod body and the outer member are rapidly moved relative to each other; when the rod body and the outer member rotate relative to each other in a hindered manner, the first thread is disengaged from the third thread, the second thread is engaged with the fourth thread, the second thread and the fourth thread are locked with each other, and thus the rod body and the outer member are fixed with each other; when the second thread and the fourth thread are loosened with each other, the second thread is disengaged from the fourth thread, the first thread is engaged with the third thread, and the rod body and the outer member are rapidly moved relative to each other.

2. The fastening structure as claimed in claim 1, wherein the outer member is a ring-shape.

3. The fastening structure as claimed in claim 1, wherein the outer member is formed of at least one arc portion, and the third thread and the fourth thread of each arc portion are discontinuous but with continuity.

4. A holder having the fastening structure with two different threads as claimed in claim 1, wherein the holder is used for clamping a mobile phone, the holder comprises a first clamping portion and a second clamping portion, the second clamping portion is provided with the outer member at a suitable location, the rod body is penetrated into the holder from an outside of the first clamping portion and penetrated through the outer member, one end of the rod body is provided with a position limiter for limiting relative positions of the rod body and the first clamping portion but allowing to rotate with respect to each other, the mobile phone is placed between the first clamping portion and the second clamping portion, by rotating the rod body, the first thread of the rod body and the third thread of the outer member are engaged and rotated relative to each other, the first clamping portion and the second clamping portion are rapidly moved toward each other for clamping the mobile phone, and then, the rod body is rotated toward a locking direction, the first thread and the third thread are disengaged from each other, and the second thread and the fourth thread are engaged with each other to fasten the rod body and the outer member with each other, so that the first clamping portion and the second clamping portion tightly clamp the mobile phone, otherwise, the rod body is rotated toward a loosening direction, the second thread and the fourth thread are disengaged from each other, the first thread and the third thread are engaged with each other, and the first clamping portion and the second clamping portion are rapidly moved relative to each other, so that the mobile phone can be taken out of the holder.
